(19) United States
(12) Patent Application Publication
(10) Pub. No.: US 2025/0217094 A1
(43) Pub. Date: Jul. 3, 2025

(54) CONTROL METHOD AND APPARATUS

(71) Applicant: Lenovo (Beijing) Limited, Beijing (CN)

(72) Inventors: Ying GAO, Beijing (CN); Xiaoren CHENG, Beijing (CN)

(21) Appl. No.: 19/006,940

(22) Filed: Dec. 31, 2024

(30) Foreign Application Priority Data
Jan. 2, 2024 (CN) 202410009382.8

(51) Int. Cl. G06F 3/14; G06F 3/0481; G06F 3/0484; G06F 3/0487; G06F 9/445

(52) U.S. Cl. CPC G06F 3/1446; G06F 3/0481; G06F 3/0484; G06F 3/0487; G06F 9/44505; G06F 2203/04803

(57) ABSTRACT

A control method includes, in response to a target event, determining a target operation area, and configuring a control strategy corresponding to the target event for the target operation area to control the electronic device to respond to a target operation acting on the target operation area according to the corresponding control strategy. The target operation area belongs to an operation area formed by a hardware module of an electronic device.

### CROSS-REFERENCE TO RELATED APPLICATION

The present disclosure claims priority to Chinese Patent Application No. 202410009382.8, filed on Jan. 2, 2024, the entire content of which is incorporated herein by reference.

### TECHNICAL FIELD

The present disclosure is related to the device control technology field and, more particularly, to a control method and an apparatus.

### BACKGROUND

Electronic devices often need to be accurately and responsively controlled. However, electronic devices often have false responses due to false recognition or inaccurate control. Thus, the user experience is poor.

### SUMMARY

An aspect of the present disclosure provides a control method. The method includes, in response to a target event, determining a target operation area, and configuring a control strategy corresponding to the target event for the target operation area to control the electronic device to respond to a target operation acting on the target operation area according to the corresponding control strategy. The target operation area belongs to an operation area formed by a hardware module of an electronic device.

An aspect of the present disclosure provides a control apparatus, including a determination module and a configuration module. The determination module is configured to determine a target operation area in response to a target event. The target operation area belongs to an operation area formed by a hardware module of an electronic device. The configuration module is configured to configure a control strategy corresponding to the target event for the target operation area, to control the electronic device to respond to a target operation acting on the target operation area.

An aspect of the present disclosure provides an electronic device including a display unit, an input unit, one or more processors, and one or more memories. The one or more memories store a program that, when executed by the one or more processors, causes the one or more processors to in response to a target event, determine a target operation area, and configure a control strategy corresponding to the target event for the target operation area to control the electronic device to respond to a target operation acting on the target operation area according to the corresponding control strategy. The target operation area belongs to an operation area formed by a hardware module of an electronic device.

### BRIEF DESCRIPTION OF THE DRAWINGS

FIG. 1 illustrates a schematic flowchart of a control method according to some embodiments of the present disclosure.

FIG. 2 illustrates a schematic diagram showing an implementation scene of a control method according to some embodiments of the present disclosure.

FIG. 3 illustrates a schematic diagram showing another implementation scene of a control method according to some embodiments of the present disclosure.

FIG. 4 illustrates a schematic diagram showing another implementation scene of a control method according to some embodiments of the present disclosure.

FIG. 5 illustrates a schematic flowchart of a control method according to some embodiments of the present disclosure.

FIG. 6 illustrates a schematic diagram showing another implementation scene of a control method according to some embodiments of the present disclosure.

FIG. 7 illustrates a schematic structural diagram of a control apparatus according to some embodiments of the present disclosure.

FIG. 8 illustrates a schematic architectural diagram of an electronic device according to some embodiments of the present disclosure.

### DETAILED DESCRIPTION OF THE EMBODIMENTS

The technical solutions of embodiments of the present disclosure are described in detail below in conjunction with the accompanying drawings of embodiments of the present disclosure. Obviously, the embodiments described are only some embodiments of the present disclosure, not all embodiments. Based on embodiments of the present disclosure, all other embodiments obtained by those skilled in the art without creative efforts shall fall within the scope of the present disclosure.

In related technologies, the accuracy and sensitivity of the control of an electronic device are known challenges. The device often requires precise control. However, the actual operation is often hindered by a false operation caused by false recognition or inaccurate control. For example, many devices rely on fixed control strategies, which limits the ability of the devices to adapt to changing environments and user needs. Additionally, when the devices process complex or unclear inputs, the devices often cannot accurately determine the real intention of the user. Thus, the devices can respond to a user operation incorrectly.

To solve the above technical problems, embodiments of the present disclosure provide a control method.

To make the above objectives, features, and advantages of the present disclosure more apparent and understandable, the present disclosure is further described in detail in conjunction with the accompanying drawings and specific embodiments.

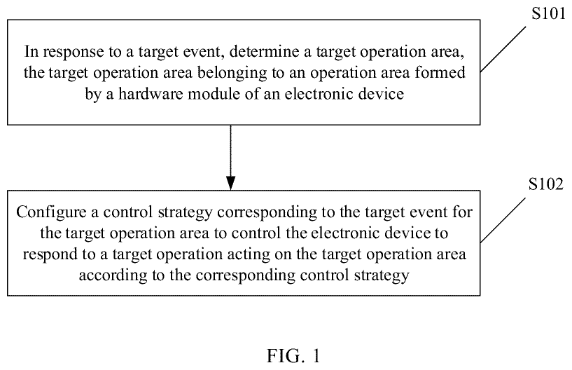

FIG. 1 illustrates a schematic flowchart of a control method according to some embodiments of the present disclosure. The method can be applied to an electronic device. The type of the electronic device is not limited. As shown in FIG. 1, the method includes but is not limited to the following steps.

At S101, in response to a target event, a target operation area is determined. The target operation area belongs to an operation area formed by a hardware module of the electronic device.

The hardware module of the electronic device can collect the operation data of an operating body in the operation area. The electronic device can respond to the operation data. The operation data can represent an operation of the operating body performed in the operation area.

In response to the target event, determining the target operation area can include, if the target event includes determining the target operation area for the first time, configuring parameters of the target operation area corresponding to the target event to determine the target operation area.

Configuring the parameters of the target operation area corresponding to the target event can include configuring, by the user, the parameters of the target operation area to configure the target operation area by the user.

Configuring the parameters of the target operation area corresponding to the target event can include obtaining configuration parameters for a history target operation area determined by the target event, and configuring the parameters of the target operation area as the configuration parameters of the history target operation area to configure the history target operation area as the target operation area.

The parameters of the target operation area can include but are not limited to at least one of a position of the target operation area, an area of the target operation area, or sensitivity of the target operation area. The sensitivity of the target operation area and the force of the operating body acting on the target operation area can be inversely related. When the sensitivity is higher, the user needs less force to respond to the operation. When the sensitivity is lower, the user may need a larger force to obtain the operation response.

The hardware module of the electronic device can include a hardware input module or a hardware output module of the electronic device. For example, the hardware input module can include but is not limited to a sensor module. For example, the sensor module can include any one or more of a touch sensor, a motion sensor, a proximity sensor, a pressure sensor, an optical sensor, an infrared sensor, and an ultrasonic sensor. The hardware output module can include but is not limited to a display module, a naked-eye 3D display module, etc. The display module and the naked-eye 3D display module can be different. The display module can be configured to display two-dimensional content, and the naked-eye 3D display module can be configured to display three-dimensional content.

At S102, the control strategy of the target event for the target operation area is used to control the electronic device to respond to the target operation applied in the target operation area.

The control strategy controlling the electronic device can include controlling the electronic device to respond to the target operation acting on the target operation area. In some embodiments, after the hardware module of the electronic device collects the operation data of the operating body in the target operation area, the electronic device can respond to the operation data based on the control strategy configured for the target operation area.

The control strategy can include but is not limited to the called firmware program and/or the responsive operation feature.

The called firmware program can include but is not limited to at least one of a relative positioning touch firmware program, an absolute positioning touch firmware program, or a non-contact control firmware program.

For example, configuring the relative positioning touch firmware program for the target operation area can enable the electronic device to respond to a touch operation acting on the target operation area based on the relative positioning touch firmware program, and determine the relative position on the display screen of the electronic device corresponding to the touch operation, which is used to move the cursor on the display screen or perform other types of functions.

Configuring the absolute positioning touch firmware program for the target operation area can enable the electronic device to respond to the touch operation acting on the target operation area based on the absolute positioning touch firmware program, and determine the absolute position on the display screen of the electronic device corresponding to the touch operation, which is used to input corresponding information or perform corresponding functions.

Configuring the non-contact control firmware program for the target operation area can enable the electronic device to respond to a non-contact operation acting on the target operation area based on the non-contact control firmware program, which is used to input corresponding information or perform corresponding functions.

The responsive operation feature can include but is not limited to at least one of a contact area of the touch operation, a pressing pressure of the touch operation, and a recognition area of the non-contact operation.

In some embodiments, by determining the target operation area and configuring the corresponding control strategy for the area, the operation area intended by the user can be specified. That is, in the method of embodiments of the present disclosure, the system can distinguish between intentional touches and non-target false touches. The distinguishment can be based on a touch feature of the user, such as a position, a duration, a pressure, and a mode of the touch (e.g., tap, long press, or swipe). For example, if a touch action occurs within a predetermined operation area and satisfies a preset touch mode of the area (such as a specific tap or swipe method), the system can determine the touch as an intentional operation. On the contrary, if the touch occurs outside the predetermined area or the touch method does not satisfy any preset operation mode, the system can determine the touch as a non-target false touch and does not respond to the false touch operation.

In summary, in embodiments of the present disclosure, the target operation area can be determined by responding to the target event. The target operation area can belong to the operation area formed by the hardware module of the electronic device. The control strategy of the corresponding target event can be configured for the target operation area to control the electronic device to respond to the target operation acting on the target operation area. Thus, the electronic device can respond to the target operation acting on the target operation area based on the control strategy to ensure the accuracy of the response to the target operation acting on the target operation area, which improves the user experience.

In some other embodiments, a control method is provided as a detailed solution for step S101 of the control method above. Step S101 can include but is not limited to the following steps.

At S1011, in response to a target event, the target display area of the display module of the electronic device is determined as the target operation area.

The target display area of the display module can be configured to display two-dimensional content. For example, the target display area can be configured to display a virtual keyboard, a virtual touchpad, or an application interface. The display module can be configured to collect touch data of an operating body acting in the display area of the virtual keyboard, the display area of the virtual touchpad, or the application interface. Thus, corresponding control strategies can be configured for different pieces of touch data. Accordingly, step S102 can include configuring the control strategy corresponding to the target event for the display area of the virtual keyboard or the display area of the virtual touchpad. Thus, the electronic device can respond to the touch data from the display area of the virtual keyboard or the display area of the virtual touchpad based on the control strategy.

The control strategy configured for the display area of the virtual keyboard and the control strategy configured for the display area of the virtual touchpad can be different.

For example, in some embodiments, the target event can be a video playback event of the electronic device, the target display area can be a part of the screen configured for video playback on a cell phone. The control strategy configured in the target display area can be a touch action corresponding to a video playback scene. For example, only a clear touch action (e.g., double-click or long-press) can be recognized. Thus, when the user only lightly touches the screen to adjust the grip, the video will not be accidentally paused or played.

In some other embodiments, the target event can include an e-book display event by the electronic device. The target display area can include an edge portion of the screen of the electronic reader. The control strategy configured in the target display area can include a response to a specific light swipe action. Thus, a page can be turned on the screen only when the user performs a slight swipe at the edge, which reduces false touch during reading. Meanwhile, the sensitivity in page-turning can be improved.

At S1012, in response to the target event, a sensing area of the sensor of the electronic device is determined as the target operation area.

The sensor of the electronic device can include but is not limited to at least one of a camera, a radar, a TOF sensor, a motion sensor, or a pressure sensor.

Taking the camera as an example, the sensing area of the sensor of the electronic device can be further described. For example, a recording area of the camera can be determined as the target operation area. The camera can be configured to collect images of the operating body in the recording area. Accordingly, step S102 can include configuring the control strategy corresponding to the target event for the recording area to allow the electronic device to process the image based on the control strategy, determine an input gesture of the operating body, and respond to the input gesture.

For example, in some embodiments, the target event can include controlling smart home devices, such as adjusting lighting or temperature. The target sensing area can include a specific gesture control area in a room. The control strategy configured in the target sensing area can include recognizing a specific gesture. For example, the home device can only respond when the user performs a specific waving or a point pressing action. With such a configuration, false operations due to random movements or non-target actions can be reduced. Meanwhile, the home device can be ensured to quickly respond to the correct gesture.

In some other embodiments, the target event can include controlling music or navigation of an in-car system. The target control area can be a specific gesture recognition area in the cockpit. The control strategy configured in the target control area can include recognizing a simple and clear gesture, such as head nodding or hand swiping. Thus, only an intentional gesture operation can be recognized and responded to during driving. Thus, false touch risk can be reduced, and a quick and accurate control reaction can be ensured.

At S1013, in response to the target event, a light projection area of a naked-eye 3D display module of the electronic device is determined as the target operation area.

The light projection area of the naked-eye 3D display module of the electronic device can be used to display 3D content.

The naked-eye 3D display module can be configured to collect non-contact operation data of the operating body in the light projection area. Accordingly, step S102 can include configuring the control strategy of the corresponding target event for the light projection area to allow the electronic device to respond to the non-contact operation data from the light projection area based on the control strategy.

For example, in some embodiments, the target event can include the interaction experience of a player in a virtual reality (VR) game. The target display area can be a part of the field of view of the player used for viewing and interaction with the 3D object. The control strategy configured in the target display area can include a specific gesture and head movement recognition for the VR environment. For example, only when the player performs the specific gesture of specific head movement, the system can recognize the gesture or the head movement as a valid interaction. This configuration can be used to ensure that a game element is not accidentally touched when the player performs routine observation or slight head movement. Thus, the false touch can be reduced, while high responsiveness to the intentional operation can be ensured.

In some other embodiments, the target event can include a complex scientific model of display and interaction of an educational application. The target display area can be a screen area or space area used for the display and interaction of the 3D model. The control strategy configured in the target display area can include recognizing the precise touch or spatial gesture, which ensures that rotation, zooming, or other interactions of the model are performed only when the student performs a specific touch or a determined gesture. This configuration can reduce the false touch during model operation, which improves the responsiveness and interaction quality of a teaching tool.

In some other embodiments, the target event can include displaying dynamic 3D advertisement content on an advertisement display board. The target display area can include a screen or projection area configured to display 3D advertisements in public places. The control strategy configured in the target display area can include recognizing gaze tracking or dwell time of a passenger. For example, only when the passerby clearly stops and looks at the advertisement for a certain time, the advertisement content can interactively change or display more information. This configuration can be used to reduce false responses triggered by random gaze movements of the passenger while ensuring high responsiveness to a genuinely interested viewer.

In the present disclosure, the specific configuration of the target event, target display area, and target control strategy are not limited. The above are only exemplary embodiments for describing the possible configuration relationships among the target event, target display area, and target control strategy, but are not limited to the situations described above.

In some embodiments, at least one of in response to the target event, determining the target display area of the display module of the electronic device as the target operation area, in response to the target event, determining the sensing area of the sensor of the electronic device as the target operation area, or in response to the target event, determining the light projection area of the naked-eye 3D display module of the electronic device as the target operation area can be the control strategy of the corresponding target event configured for the target operation area. Thus, the electronic device can respond to the target operation acting on the target display area, the sensing area of the sensor, or the light projection area based on the corresponding control strategy. Then, the accuracy of responding to the target operation acting on the target display area, the sensing area of the sensor, or the light projection area can be ensured to improve the user experience.

In some other embodiments, a control method is provided as a refined solution for steps S1011, S1012, and S1013 of the control method above. Step S1011 can include but is not limited to at least one of the following steps.

At S10111, a circle-selection operation of the target object in the target display area is detected, and a circle-selection area corresponding to the circle-selection operation is determined as the target operation area.

In the present disclosure, the target object can perform the circle-selection operation in the target display area as needed, which is not limited here. For example, if the target object needs a part of the display area to display the virtual touchpad, a display area that is not prone to false touch can be circle-selected from the target display area to display the virtual touchpad.

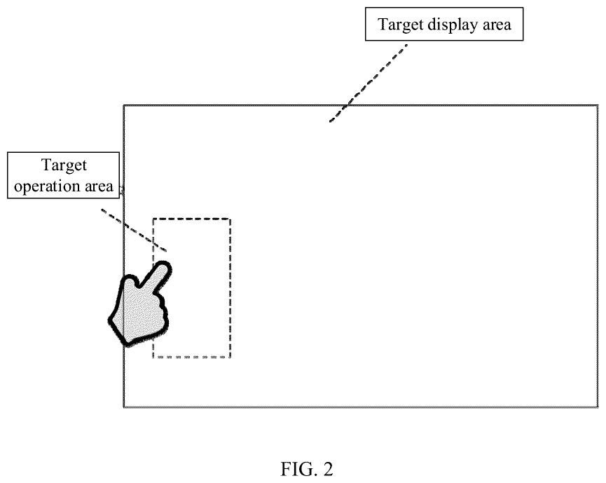

For example, as shown in FIG. 2, the target object circle selects a rectangular area in the target display area. The selected rectangular area that is circle-selected is used as the target operation area. The target operation area is a part of the target display area.

At S10112, if the target display area includes a plurality of sub-display areas, in response to a selection instruction of the target object for the sub-display area, the selected sub-display area is determined as the target operation area.

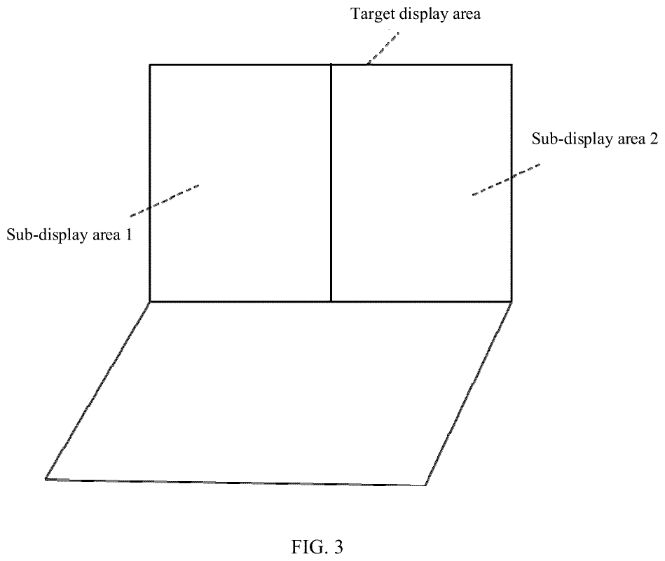

In some embodiments, the electronic device can include one display module. The target display area can be a target display area of the display module. Accordingly, the plurality of sub-display areas can be the plurality of sub-display areas of the display module in a split-screen mode. For example, as shown in FIG. 3, the display module includes two sub-display areas in the split-screen mode, including a sub-display area 1 and a sub-display area 2. The target object can select sub-display area 1 as the target operation area.

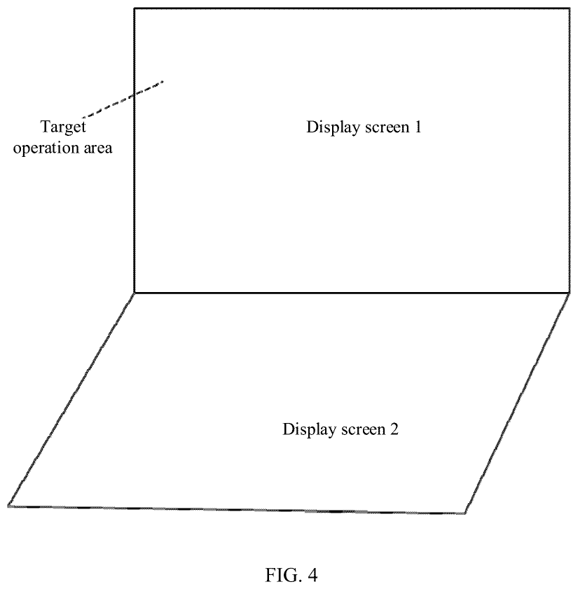

The electronic device can include a plurality of display modules. For example, the electronic device can include 2 or 3 display screens. Each display screen can correspond to a sub-display area. For example, as shown in FIG. 4, the electronic device includes 2 display screens, such as display screen 1 and display screen 2. The target object can select the sub-display area corresponding to the display as the target operation area.

At S10113, if the target display area switches from the split-screen mode to a full-screen mode, the target display area in the full-screen mode is determined as the target operation area.

The target display area in the full-screen mode can be determined as the target operation area. The area of the target operation area can be consistent with the area of the target display area, which ensures that the area of the target operation area is relatively large.

Step S1012 can include the following steps.

At S10121, the selection operation of the target object in the sensing area of the sensor is detected, and the selection area corresponding to the selection operation is determined as the target operation area.

In some embodiments, the target object can select the corresponding position parameters from the position parameters of the spatial position of the sensing area of the sensor, and determine the area represented by the selected position parameter as the target operation area.

The target operation area can be a part of the sensing area of the sensor.

Step S1013 can include but is not limited to the following areas.

At S10131, the selection operation of the target object in the light projection area of the naked-eye 3D display module is detected, and the selection area corresponding to the selection operation is determined as the target operation area.

In some embodiments, the target object can perform the circle-selection operation on the light projection area. The electronic device can collect the corresponding non-contact selection gesture and determine the area corresponding to the non-contact selection gesture as the target operation area.

In some other embodiments, a control method is provided as a refined solution for steps 1011, S1012, and S1013 of the control method above. Step S1011 can include but is not limited to.

At S10114, in response to the electronic device running the target application, the historical operation area of the target application in the display module is determined as the target operation area, or the first display area configured for the target application in the display module is determined as the target operation area.

The historical operation area of the target application in the display module can include but is not limited to the display window of the target application running in the display module in the previous running before the current running, or the display area of the virtual keyboard, or the display area of the virtual touchpad.

The first display area configured for the target application in the display module can be configured based on user-configured parameters. The first display area configured for the target application in the display module can be configured according to the display parameters of the target application. The display parameter of the target application can represent the display needs of the target application.

At S10115, when the application is in the target state, at least a part of the area in the target display area of the display module of the electronic device is determined as the target operation area.

For example, when the application is in a non-maximized state, another display area of the target display area of the display module of the electronic device except for the display area of the application can be determined as the target operation area, or a portion of the other display area can be determined as the target operation area. The area of the display area of the application in the non-maximized state can be smaller than the area of the display area of the application in a maximized state. The application can be displayed in full screen in the maximized state.

For another example, when the target display area is in a split-screen mode, the target display area can include two sub-display areas, including a first sub-display area and a second sub-display area. When the display window of the application is dragged from the first sub-display area to the second sub-display area, the first sub-display area or a portion of the first sub-display area can be determined as the target operation area.

Step S1012 can include but is not limited to at least one of the following steps.

At S10122, in response to the startup of the first application with a human presence detection function, at least a portion of the sensing area of the sensor is determined as the target operation area.

The human presence detection function can include but is not limited to a face detection function, a human posture recognition function, etc.

The first application with the human presence detection function can be used to provide an identity verification service or a control function for the electronic device or another application.

At S10123, when the application is in the target state, at least a portion of the sensing area of the sensor of the electronic device is determined as the target operation area.

When the application is in the target state, the sensor of the electronic device can obtain operation data from the target operation area. The electronic device can be configured to process the operation data based on the control strategy and input control instructions to the application in the target state to cause the application in the target state to respond to the control instructions.

For example, if the application is PPT, and when PPT is in a playback state, at least a portion of the sensing area of the TOF sensor or camera is determined as the target operation area. The user can make gesture actions in the target operation area, and the TOF sensor or camera can obtain gesture action data from the target operation area. The electronic device can process the gesture action data based on the control strategy and input a page-turning instruction to PPT to cause PPT in the playback state to respond to the page-turning instructions and turn a page.

For another example, if the application is a multimedia application (e.g., a video application or an audio application), and when the multimedia application is in the playback state, at least a portion of the sensing area of the TOF sensor or camera can be determined as the target operation area. The user can make gesture actions in the target operation area, and the TOF sensor or camera can obtain the gesture action data from the target operation area. The electronic device can process the gesture action data based on the control strategy and input a pause or fast-forward instruction to the multimedia application to cause the multimedia application in the playback state to respond to the pause instruction and stop playback or respond to the fast-forward instruction and fast-forward the playback.

Step S1013 can include but is not limited to at least one of the following steps.

At S1032, when the application is in the target state, at least a portion of the light projection area of the naked-eye 3D display module of the electronic device is determined as the target operation area.

For example, when the application is in the non-maximized state, other light projection area of the light projection area of the naked-eye 3D display module of the electronic device except for the light projection area where the application is located can be determined as the target operation area, or a portion of the other light projection area can be determined as the target operation area. The area of the light projection area where the application is in the non-maximized state can be smaller than the area of the light projection area where the application is in the maximized state. The application can be displayed on a full screen in the maximized state.

In some embodiments, by running the application, starting the application, or when the application is in the target state, a portion of the area can be determined as the target operation area. The control strategy of the corresponding target event can be configured for the target operation area. Thus, the electronic device can respond to the target operation acting on the target operation area based on the corresponding control strategy, which ensures the accuracy of the response to the target operation acting on the target operation area and improves the user experience.

In some other embodiments of the present disclosure, a control method is provided as a refined solution for steps S1011, S1012, and S1013 of the control method above. Step S1011 can include but is not limited to the following steps.

At S10116, in response to the electronic device changing from the first form to the second form, the second display area of the display module is determined as the target operation area. The second display area is a portion or all of the display area of the display module.

The first form and the second form can be different. For example, the portion or all of the display area of the display module can be invisible in the first form, and the portion or all of the display area of the display module can be visible in the second form.

For example, if the electronic device is foldable, and when the electronic device changes from a folded form to an unfolded form, the second display area in the unfolded form can be determined as the target state. The second display area can be the display area that is invisible in the folded form.

In some other embodiments, if the electronic device changes from the unfolded form to the folded form, the second display area in the folded form can be determined as the target operation area. The second display area can be the display area that is invisible in the unfolded state.

For another example, if the electronic device is a scrollable electronic device, and when the electronic device changes from a rolled form to the unfolded form, the second display area in the unfolded form can be determined as the target operation area. The second display area can be the display area that is invisible in the rolled form.

At S10117, in response to the electronic device rotating from the first position relative to the body of the electronic device to the second position relative to the body of the electronic device, the second display area of the display module is determined as the target operation area. The second display area is a portion or all of the display area of the display module.

Step S1012 can include but is not limited to the following steps.

At S10124, in response to the electronic device changing from the third form to the fourth form, the first sensing area of the sensor is determined as the target operation area. The first sensing area is a portion or all of the sensing area of the electronic device in the fourth form.

The third form and the fourth form can be different. When the form of the electronic device changes, the sensing area of the sensor can change accordingly.

For example, if the electronic device is foldable, and when the electronic device changes from the folded form to the unfolded form, the first sensing area in the unfolded form can be determined as the target operation area. The first sensing area can be a portion or all of the sensing area in the unfolded form.

In some other embodiments, if the electronic device changes from the unfolded form to the folded form, the first sensing area in the folded form can be determined as the target operation area. The first sensing area can be a portion or all of the sensing area in the folded form.

Step S1013 can include but is not limited to the following step.

At S10133, in response to the electronic device changing from the fifth form to the sixth form, the first light projection area of the naked-eye 3D display module is determined as the target operation area. The first light projection area is a portion or all of the light projection area of the naked-eye 3D display module when the electronic device is in the sixth form.

The fifth form and the sixth form can be different. When the form of the electronic device changes, the light projection area of the naked-eye 3D display module can change accordingly.

For example, if the electronic device is foldable, and when the electronic device changes from the folded form to the unfolded form, the first light projection area in the unfolded form is determined as the target operation area. The first light projection area can be a portion or all of the light projection area in the unfolded form.

In some other embodiments, if the light projection area formed by the naked-eye 3D display module is visible in the fifth form and not visible in the sixth form, in response to the electronic device changing from the fifth form to the sixth form, another area outside the light projection area of the naked-eye 3D display module can be determined as the target operation area.

For example, the other area can be a portion or all of the sensing area of the sensor in the sixth form.

In some embodiments, through the change in the form of the electronic device, the corresponding area can be determined as the target operation area. The control strategy of the corresponding target event configured for the target operation area can cause the electronic device to respond to the target operation acting on the target operation area based on the corresponding control strategy, which ensures the accuracy of the response to the target operation acting on the target operation area and improves the user experience.

In some other embodiments, a control method is provided as a refined solution for steps S1011, S1012, and S1013 of the control method above. Step S1011 can include but is not limited to at least one of the following steps.

At S10117, in response to a communication connection established between the electronic device and the terminal device, the display area of the display module of the electronic device corresponding to the identification information of the terminal device is determined as the target operation area.

The identification information of the terminal device can be used to distinguish the terminal device from another terminal device. The terminal devices can have different identification information.

When the electronic device establishes communication connections with different terminal devices, the target operation areas of the display module of the electronic device can be different from each other.

In the target operation area corresponding to the terminal device, the target object can perform a corresponding operation to control the terminal device.

At S10118, in response to the electronic device disconnecting the communication connection with the terminal device, the third display area of the display module of the electronic device is determined as the target operation area.

After the electronic device disconnects the communication connection with the terminal device, the electronic device may no longer need to interact with the terminal device. Therefore, the third display area of the display module of the electronic device can be determined as the target operation area. The target object can perform a corresponding operation in the target operation area to control the electronic device or application to execute corresponding functions.

The third display area can be the target display area of the display module or a portion of the target display area.

At S10119, in response to the communication connection established between the electronic device and the terminal device, the display area corresponding to the type of communication connection in the display module of the electronic device is determined as the target operation area.

Correspondingly, the control strategy can be configured for the target operation area. The electronic device can respond to the target operation acting on the target operation area and corresponding to the type of communication connection based on the control strategy.

The types of communication connection can include but are not limited to a wireless connection (such as Wi-Fi, Bluetooth connection, UWB connection, etc.) or a wired connection (such as a USB wired connection, a DP wired connection, a HDMI wired connection, etc.).

Step S1012 can include but is not limited to at least one of the following steps.

At S10125, in response to the communication connection established between the electronic device and the terminal device, the sensing area corresponding to the identification information of the terminal device of the sensor of the electronic device is determined as the target operation area.

The identification information of the terminal device can be used to distinguish the terminal device from another terminal device. The identification information of the terminal devices can be different.

When an electronic device establishes the communication connection with different terminal devices, the target operation areas of the sensing areas of the sensors of the electronic device can be different from each other.

In the target operation area corresponding to the terminal device, the target object can perform a corresponding operation to control the terminal device.

At S10126, in response to the electronic device disconnecting the communication connection with the terminal device, the second sensing area of the sensor of the electronic device is determined as the target operation area.

After the electronic device disconnects the communication connection with the terminal device, the electronic device may no longer need to interact with the terminal device. Therefore, the second sensing area of the sensor of the electronic device can be determined as the target operation area. The target object can perform corresponding operations in the target operation area to control the electronic device or application to execute corresponding functions.

The second sensing area can be a portion or all of the sensing area of the sensor.

At S10127, in response to the electronic device establishing the communication connection with the terminal device, the sensing area corresponding to the type of communication connection in the sensor of the electronic device is determined as the target operation area.

Correspondingly, the control strategy can be configured for the target operation area. The electronic device can respond to the target operation acting on the target operation area and corresponding to the type of communication connection based on the control strategy.

The types of the communication connection can include but is not limited to a wireless connection (such as Wi-Fi, a Bluetooth connection, a UWB connection, etc.) or a wired connection (such as a USB wired connection, a DP wired connection, a HDMI wired connection, etc.).

Step S1013 can include but is not limited to at least one of the following steps.

At S10134, in response to the electronic device establishing a communication connection with the terminal device, the light projection area corresponding to the identification information of the terminal device in the naked-eye 3D display module of the electronic device is determined as the target operation area.

The identification information of the terminal device can be used to distinguish the terminal device from another terminal device. The identification information of the terminal devices can be different.

When the electronic device establishes communication connections with different terminal devices, the target operation areas in the light projection area of the naked-eye 3D display module of the electronic device can be different from each other.

In the target operation area corresponding to the terminal device, the target object can perform corresponding operations to control the terminal device.

At S10135, in response to the electronic device disconnecting the communication connection with the terminal device, the second light projection area in the naked-eye 3D display module of the electronic device is determined as the target operation area.

After the electronic device disconnects the communication connection with the terminal device, the electronic device may no longer need to interact with the terminal device. Therefore, the second light projection area in the naked-eye 3D display module of the electronic device can be determined as the target operation area. The target object can perform corresponding operations in the target operation area to control the electronic device or application to execute the corresponding functions.

The second light projection area can be a portion or all of the light projection area of the naked-eye 3D display module.

At S10136, in response to the electronic device establishing the communication connection with the terminal device, the light projection area corresponding to the type of communication connection in the naked-eye 3D display module of the electronic device is determined as the target operation area.

Accordingly, to configure the control strategy for the target operation area, the electronic device can respond to the target operation acting on the target operation area and corresponding to the type of communication connection based on the control strategy.

The types of communication connection can include but are not limited to a wireless connection (such as a Wi-Fi, a Bluetooth connection, a UWB connection, etc.) or wired connections (such as a USB wired connection, a DP wired connection, a HDMI wired connections, etc.).

In some embodiments, by establishing or disconnecting the communication connection between the electronic device and the terminal device, the corresponding area can be determined as the target operation area. The control strategy of the corresponding target event can be configured for the target operation area. Thus, the electronic device can respond to the target operation acting on the target operation area based on the corresponding control strategy, which ensures the accuracy of the response to the target operation acting on the target operation area and improves the user experience.

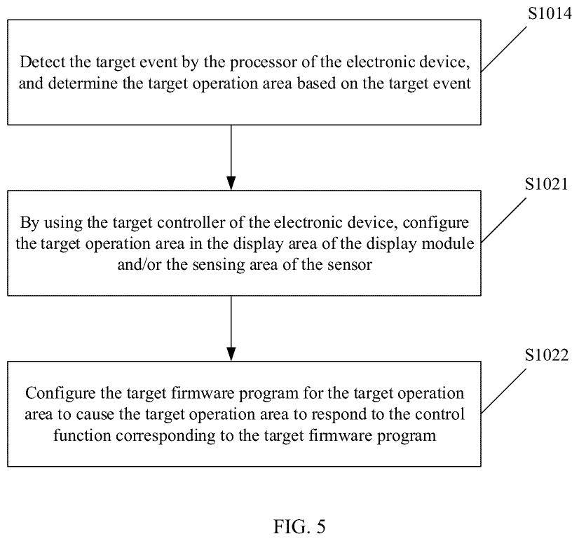

In some other embodiments, FIG. 5 illustrates a schematic flowchart of a control method according to some embodiments of the present disclosure. The control method is provided as a refined solution for steps S101 and S102 of the control method above. As shown in FIG. 5, step S101 includes but is not limited to the following steps.

At S1014, the target event is detected by the processor of the electronic device, and the target operation area is determined based on the target event.

In some embodiments, determining the target operation area based on the target event can include but is not limited to determining the configuration parameters of the target operation area based on the target event.

The configuration parameters can include but are not limited to at least one of the positions of the target operation area, the area of the target operation area, or the sensitivity of the target operation area. For example, a coordinate range (i.e., the position and area of the target operation area) and the sensitivity of the target touch area can be determined based on the target event.

Step S102 can include but is not limited to the following steps.

At S1021, by using the target controller of the electronic device, the target operation area is configured in the display area of the display module and/or the sensing area of the sensor.

In some embodiments, by using the target controller of the electronic device, the target operation area can be configured in the display area of the display module and/or the sensing area of the sensor based on the configuration parameters of the target operation area. The target operation area can match the configuration parameters.

For the display module, the target controller can include a screen controller, a scaler chip, an EC chip, an MCU (microcontroller unit), or a CPU (central processing unit).

For the sensor, the target controller can include an EC, an MCU, or a CPU.

The target controller can be different from the processor.

At S1022, the target firmware program is configured for the target operation area to cause the target operation area to respond to the control function corresponding to the target firmware program.

The target firmware program can be used to enable the target operation area to respond to the control function corresponding to the target firmware program.

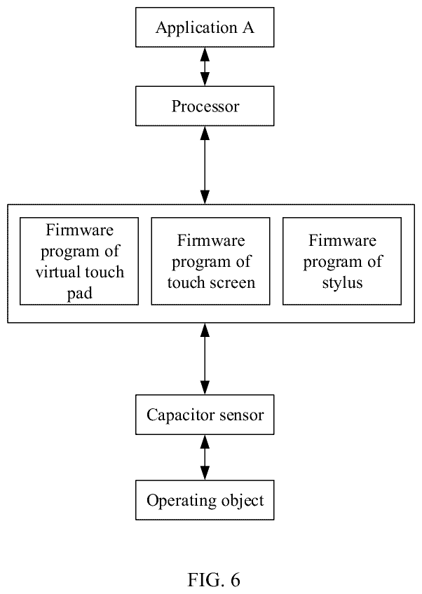

For example, if the display module includes a touch screen, as shown in FIG. 6, the processor of the electronic device is configured to detect that the electronic device runs application A, and the display area of the virtual touchpad configured for application A in the touch screen can be the target operation area. The target controller of the electronic device can be configured to configure the display area of the virtual touchpad in the display area of the touch screen, and configure the firmware program corresponding to the virtual touchpad for the display area of the virtual touchpad. The firmware program of the touch screen can be configured for other display area in the display area of the touch screen except for the display area of the virtual touchpad.

If the capacitive sensor included in the display module collects the operation data of the operating body in the display area of the touch screen, the target controller can determine whether the operation data is from the display area of the virtual touchpad. If the operation data is from the display area of the virtual touchpad, the target controller can process the operation data based on the firmware program corresponding to the virtual touchpad. Whether the target operation in the display area of the virtual touchpad corresponds to the set first touch control operation feature (e.g., a finger feature) can be determined. If the operation data can be reported to the operating system of the electronic device corresponding to the set first touch control feature, the operating system of the electronic device can respond to the operation data corresponding to the firmware program of the virtual touchpad.

If the target operation does not correspond to the set first touch control operation feature, the operation data may not be reported to the operating system of the electronic device, which prevents a false touch in the virtual touchpad and incorrect responses by the electronic device.

If the operation data is not from the display area of the virtual touchpad, the target controller can process the operation data based on the corresponding firmware program to determine whether the target operation in the other display area in the touch screen except for the display area of the virtual touchpad corresponds to the set second touch control operation feature. If the target operation corresponds to the second touch control operation feature, the operation data can be reported to the operating system of the electronic device. The operating system of the electronic device can respond to the operation data corresponding to the firmware program of the touch screen.

The second touch operation feature set by the firmware program of the touch screen can be different from the first touch operation feature set by the firmware program of the virtual touchpad. For example, the touch contact area represented by the first touch control operation feature can be smaller than the touch contact area represented by the second touch operation feature, and/or the touch force represented by the first touch operation feature can be greater than the touch force represented by the second touch control operation feature.

Of course, the firmware program of the stylus can be configured for the area except for the target operation area to cause the area except for the target operation area to respond to the control function corresponding to the firmware program of the stylus.

In some other embodiments, a control method is provided as a refined solution for step S1022 of the control method above. Step S1022 can include but is not limited to at least one of the following steps.

At S10221, if the target event includes running a game application, the touch control firmware program is configured in the display interface of the game application.

Configuring the touch control firmware program in the display interface of the game application can include but is not limited to configuring the firmware program of the virtual touchpad or the touch screen in the display interface of the game application.

Configuring the touch control firmware program in the display interface of the game application can cause the touch control operation area (i.e., the target operation area) of the game application can respond to the control function corresponding to the touch control firmware program.

In some other embodiments, if the target event includes running the game application, the firmware program of the sensor can be configured in the display interface of the game application.

Configuring the firmware program of the sensor in the display interface of the game application can cause the sensing area (i.e., the target operation area) of the game application to respond to the control function corresponding to the firmware program of the sensor.

At S10222, if the target event includes running a graphic editing program, the stylus firmware program and/or the pressure pad firmware program are configured in the operation interface and/or function interface of the graphic editing program.

The stylus firmware program and/or the pressure pad firmware program configured in the operation interface and/or function interface of the graphic editing program can cause the touch control operation area (i.e., the target operation area) of the graphic editing program to respond to the control function corresponding to the stylus firmware program and/or the pressure pad firmware program.

At S10223, in response to the electronic device establishing a connection with the stylus, the stylus firmware program and/or the pressure pad firmware program are configured for the target operation area.

Configuring the stylus firmware program and/or the pressure pad firmware program for the target operation area can enable the target operation area to respond to the control function corresponding to the stylus firmware program and/or the pressure pad firmware program.

Step S1022 is not limited to at least one of the above. Step S1022 can also include configuring the firmware program of the virtual touchpad for the target operation area in response to running a scrollable browsing page, configuring the firmware program of the virtual touchpad and/or the firmware program of the touch screen for the target operation area in response to detecting that the electronic device is in a laptop form, or configuring the firmware program of the touch screen for the target operation area in response to detecting that the electronic device is in the tablet form.

In some other embodiments, a control method is provided as a refined solution for steps S101 and S102 of the control method above. Step S101 can include but is not limited to the following steps.

At S1015, in response to one or more target events, one or more target operation areas are determined.

In response to one target event, one or more target operation areas can be determined. For example, in response to the electronic device running a game application, two target operation areas including a display area of the virtual touchpad and a display area of the virtual keyboard can be determined.

In some embodiments, one target operation area can be determined in response to a plurality of target events. For example, in response to the electronic device running a game application and a graphic editing program, one target operation area can be determined as the display area of the virtual touchpad. The game application and the graphic editing program can be controlled through the display area of the virtual touchpad.

In some other embodiments, a plurality of target operation areas can be determined in response to the plurality of target events. For example, in response to the electronic device running the game application and the graphic editing program, a plurality of target operation areas including the display area of the first virtual touchpad and the display area of the second virtual touchpad can be determined. The game application can be controlled through the display area of the first virtual touchpad, and the graphic editing program can be controlled through the display area of the second virtual touchpad.

Step S101 can also include but is not limited to the following steps.

At S1016, a new target event is detected, and the target operation area is updated.

For example, the current target operation area can be the display area of the first virtual touchpad determined in response to the electronic device running the game application. When the electronic device is detected to run the graphic editing program (i.e., a new target event), a display area of the new second virtual touchpad can be determined to update the target operation area.

Accordingly, step S102 can include but is not limited to at least one of the following steps.

At S1023, a control strategy corresponding to a target event is configured for a target operation area.

For example, the target event can include the electronic device running the game application, and the target operation area can include the display area of the virtual touchpad. A control strategy corresponding to running the game application can be configured for the display area of the virtual touchpad. The control strategy can be the firmware program of the virtual touchpad.

At S1024, a plurality of control strategies corresponding to a plurality of target events are configured for a plurality of target operation areas. The plurality of control strategies are the same or different.

For example, the plurality of target events can include running the game application and the graphic editing program, and the plurality of target operation areas can include the display area of the first virtual touchpad corresponding to the game application and the display area of the second virtual touchpad corresponding to the graphic editing program. The same control strategy or different control strategies can be configured for the display area of the first virtual touchpad and the display area of the second virtual touchpad corresponding to the graphic editing program. The control strategy can include the firmware program of the virtual touchpad.

At S1025, a new target event is detected, and the control strategy is updated.

For example, the current target operation area can include the display area of the first virtual touchpad determined in response to the electronic device running the game application. When the electronic device is detected to run the graphic editing program (i.e., a new target event), a new display area of the second virtual touchpad can be determined. A control strategy can be configured for the display area of the second virtual touchpad to update the control strategy.

The control strategy configured for the display area of the second virtual touchpad can be the same as or different from the control strategy configured for the display area of the first virtual touchpad.

Then, embodiments of the present disclosure provide a control apparatus. The description of the control apparatus can refer to the description of the control method above.

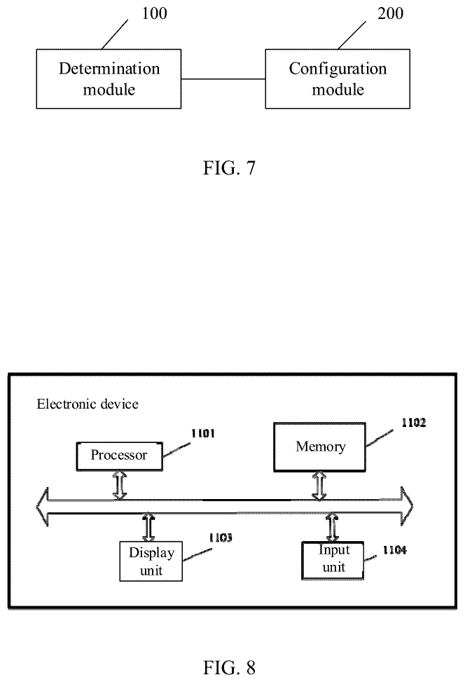

As shown in FIG. 7, the control apparatus includes a determination module 100 and a configuration module 200.

The determination module 100 can be configured to determine the target operation area in response to the target event. The target operation area can belong to the operation area formed by the hardware module of the electronic device.

The configuration module 200 can be configured to configure the control strategy corresponding to the target event for the target operation area to control the electronic device to respond to the target operation acting on the target operation area.

The determination module 100 can be configured to perform at least one of determining the target display area of the display module of the electronic device as the target operation area in response to the target event, determining the sensing area of the sensor of the electronic device as the target operation area in response to the target event, or determining the light projection area of the naked-eye 3D display module of the electronic device as the target operation area in response to the target event.

The determination module 100 determining the target operation area in response to the target event can include at least one of detecting the circle-selection operation of the target object in the target display area and determining the circle-selection area corresponding to the circle-selection operation as the target operation area, detecting the selection operation of the target object in the sensing area of the sensor and determining the selection area corresponding to the selection operation as the target operation area, if the target display area includes a plurality of sub-display areas, determining the selected sub-display area as the target operation area in response to the selection instruction of the target object for the sub-display area, or if the target display area is switched from the split-screen mode to the full-screen mode, determining the target display area in the full-screen mode as the target operation area.

The determination module 100 determining the target operation area in response to the target event can include at least one of determining the history operation area of the target application in the display module as the target operation area or determining the first display area configured for the target application in the display module as the target operation area in response to the electronic device running the target application, in response to the startup of the first application having the human presence detection function, determining at least a portion of the sensing area of the sensor as the target operation area, when the application is in the target state, determining the at least a portion of the sensing area of the sensor of the electronic device as the target operation area, when the application is in the target state, determining at least a portion of the target display area of the display module of the electronic device as the target operation area, or when the application is in target state, determining at least a portion of the light projection area of the naked-eye 3D display module of the electronic device as the target operation area.

The determination module determining the target operation area in response to the target event can include at least one of determining the second display area of the display module as the target operation area in response to the electronic device switching from the first form to the second form, the second display area being a portion of all of the display area of the display module, determining the first sensing area of the sensor as the target operation area in response to the electronic device switching from the third form to the fourth form, the first sensing area being a portion or all of the sensing area of the electronic device in the fourth form, or determining the first light projection area of the naked-eye 3D display module as the target operation area in response to the electronic device switching from the fifth form to the sixth form, the first light projection area being a portion or all of the light projection area of the naked-eye 3D display module of the electronic device in the sixth form.

The determination module 100 determining the target operation area in response to the target event can include at least one of determining the display area of the display module of the electronic device corresponding to the identification information of the terminal device as the target operation area in response to the communication connection between the electronic device and the terminal device being established, determining the third display area of the display module of the electronic device as the target operation area in response to the communication connection between the electronic device and the terminal device being disconnected, in response to the communication connection between the electronic device and the terminal device being established, determining the sensing area of the sensor of the electronic device corresponding to the identification information of the terminal device as the target operation area, or determining the light projection area of the naked-eye 3D display module of the electronic device corresponding to the identification information of the terminal device as the target operation area, in response to the communication connection between the electronic device and the terminal device being disconnected, determining the second sensing area of the sensor of the electronic device as the target operation area or determining the second light projection area of the naked-eye 3D display module of the electronic device as the target operation area, or in response to the communication connection between the electronic device and the terminal device being established, determining the sensing area of the sensor of the electronic device corresponding to the type of the communication connection as the target operation area, or determining the light projection area of the naked-eye 3D display module of the electronic device corresponding to the type of the communication connection as the target operation area.

The determination module 100 determining the target operation area in response to the target event can include detecting the target event through the processor of the electronic device, and determining the target operation area based on the target event.

The configuration module 200 can be configured to configure the target operation area in the display area of the display module and/or the sensing area of the sensor by using the target controller of the electronic device and configure the target firmware program for the target operation area to cause the target operation area to respond to the control function corresponding to the target firmware program.

The configuration module 200 configuring the target firmware program in the target operation area can include, if the target event includes running the game application, configuring the touch firmware program in the display interface of the game application if the target event includes running the graphic editing program, configuring the stylus firmware program and/or the pressure pad firmware program in the operation interface and/or function interface of the graphic editing program. and in response to the connection between the electronic device and the stylus being established, configuring the stylus firmware program and/or pressure pad firmware program for the target operation area.

The determination module 100 can be configured to determine one or a plurality of target operation areas in response to one or a plurality of target events or detect a new target event and update the target operation area.

The configuration module 200 can be configured to perform at least one of configuring a control strategy corresponding to a target event for the one target operation area, configuration of the plurality of control strategies corresponding to the plurality of target events for the plurality of the target operation areas, the plurality of control strategies being same or different, or detecting the new target event and updating the control strategy.

Each embodiment focuses on differences from other embodiments. The same or similar parts among the embodiments can be referred to each other. Since device embodiments are basically similar to method embodiments, the description is relatively simple. For the relevant parts, reference can be made to the description of the method embodiments.

The present disclosure also provides an electronic device. FIG. 8 illustrates a schematic architectural diagram of the electronic device according to some embodiments of the present disclosure. The electronic device can be any type of electronic device. The electronic device at least includes a processor 1101 and a memory 1102.

The processor 1101 can be configured to execute the control method above.

The memory 1102 can be used to store a program required for the processor to execute operations.

The electronic device can also include a display unit 1103 and an input unit 1104.

The electronic device can also include more or fewer parts than the electronic device shown in FIG. 8, which is not limited.

The present disclosure also provides a computer-readable storage medium. The computer-readable storage medium can store at least one instruction, at least one segment of a program, a code set, or an instruction set. The at least one instruction, the at least one segment of the program, the code set, or the instruction set can be loaded and executed by the processor to realize the control method above.

The present disclosure further provides a computer program. The computer program can include a computer instruction. The computer instruction can be stored in the computer-readable storage medium. When the computer program is running on the electronic device, any one of the control methods can be executed.

Eventually, in the specification, a relationship term such as first and second can be only used to distinguish one entity or operation from another entity or operation, and does not necessarily require or imply any actual relationship or order between these entities or operations. Moreover, the terms “include,” “comprise,” or any other variations are intended to cover non-exclusive inclusion, so that a process, method, article, or device that includes a series of elements not only includes those elements but also includes other elements not explicitly listed, or elements inherent to such a process, method, article, or device. When there are no more limitations, an element defined by the phrase “including a . . . ” does not exclude the presence of an additional identical element in the process, method, article, or device that includes the element.

For convenience of the description, when the above apparatus is described, modules divided by the apparatus above the above devices are described by dividing them into various modules based on functions. Of course, the functions of the modules can be realized in one or more software and/or hardware.

From the description of the above embodiments, those skilled in the art can clearly understand that the present disclosure can be implemented by means of software plus a necessary general hardware platform. Based on this understanding, the technical solutions of the present disclosure can be embodied in the form of a software product. The computer software product can be stored in a storage medium, such as ROM/RAM, magnetic disk, optical disk, etc., and includes several instructions to enable a computer device (which can be a personal computer, server, or network device, etc.) to execute the methods described in various embodiments or parts of the embodiments of the present disclosure.

The above provides a detailed description of the control method and apparatus in embodiments of the present disclosure. Specific examples have been used to explain the principles and implementation methods of the present disclosure. The description of the above embodiments is only used to help understand the methods and core ideas of the present disclosure. Meanwhile, for those skilled in the art, based on the ideas of the present disclosure, changes can occur in specific implementation methods and application scopes. In summary, the content of the present specification should not be understood as a limitation of the present disclosure.

What is claimed is:

1. A control method, comprising:
in response to a target event, determining a target operation area, the target operation area belonging to an operation area formed by a hardware module of an electronic device;
configuring a control strategy corresponding to the target event for the target operation area to control the electronic device to respond to a target operation acting on the target operation area according to the corresponding control strategy.

2. The method of claim 1, wherein determining the target operation area in response to the target event includes at least one of:
in response to the target event, determining the target display area of a display module of the electronic device as the target operation area;
in response to the target event, determining a sensing area of a sensor of the electronic device as the target operation area; or
in response to the target event, determining a light projection area of a naked-eye 3D display module of the electronic device as the target operation area.

3. The method of claim 2, wherein in response to the target event, determining the target operation area includes at least one of:
detecting a circle-selection operation of a target object in the target display area, and determining a circle-selection area corresponding to the circle-selection operation as the target detecting a selection operation of the target object in the sensing area of the sensor, and determining a selection area corresponding to the selection operation as the target operation area;
in response to the target display area includes a plurality of sub-display areas, and a selection instruction of the target object for the sub-display areas, determining the selected sub-display area as the target operation area; or
in response to the target display area switching from a split-screen mode to a full-screen mode, determining the target display area in full-screen mode as the target operation area.

4. The method of claim 2, wherein determining the target operation area in response to the target event includes at least one of:
in response to the electronic device running a target application, determining a historical operation area of the target application in the display module as the target operation area, or determining a first display area configured for the target application in the display module as the target operation area;
in response to startup of an application having a human presence detection function, determining at least a portion of the sensing area of the sensor as the target operation area;
in response to the application being in a first operation state, determining at least a portion of the sensing area of the sensor of the electronic device as the target operation area;
in response to the application being in a second operation state, determining at least a portion of the target display area of the display module of the electronic device as the target operation area; or
in response to the application being in a third operating state, determining at least a portion of the light projection area of the naked-eye 3D display module of the electronic device as the target operation area.

5. The method of claim 2, wherein determining the target operation area in response to the target event includes at least one of:
in response to the electronic device changing from a first form to a second form, determining a second display area of the display module as the target operation area, the second display area being a portion or all of the display area of the display module;
in response to the electronic device changing from a third form to a fourth form, determining a first sensing area of the sensor as the target operation area, the first sensing area being a portion or all of the sensing area of the electronic device in the fourth form; or
in response to the electronic device changing from a fifth form to a sixth form, determining a first light projection area of the naked-eye 3D display module as the target operation area, wherein the first light projection area is part or all of the light projection area of the naked-eye 3D display module in the sixth form.

6. The method of claim 2, wherein determining the target operation area in response to the target event includes at least one of:
in response to a communication connection between the electronic device and a terminal device being established, determining a display area corresponding to identification information of the terminal device in the display module of the electronic device as the target operation area;
in response to the communication connection between the electronic device and the terminal device being disconnected, determining a third display area of the display module of the electronic device as the target operation area;
in response to the communication connection between the electronic device and a terminal device being established, determining a display area corresponding to a type of communication connection in the display module of the electronic device as the target operation area;
in response to the communication connection between the electronic device and a terminal device being established, determining a sensing area corresponding to identification information of the terminal device in the sensor of the electronic device as the target operation area, or determining a light projection area corresponding to identification information of the terminal device in the naked-eye 3D display module of the electronic device itself as the target operation area;
in response to the communication connection between the electronic device and a terminal device being disconnected, determining a second sensing area of the sensor of the electronic device as the target operation area, or determining a second light projection area in the naked-eye 3D display module of the electronic device as the target operation area;
in response to the communication connection between the electronic device and a terminal device being established, determining a sensing area corresponding to the type of communication connection in the sensor of the electronic device itself as the target operation area, or determining a light projection area corresponding to the type of communication connection in the naked-eye 3D display module of the electronic device itself as the target operation area.

7. The method of claim 1, wherein:
determining the target operation area in response to the target event includes:
detecting the target event through a processor of the electronic device, and determining the target operation area based on the target event;
configuring a control strategy corresponding to the target event for the target operation area, comprising:
using a target controller of the electronic device to configure the target operation area in the display area of the display module and/or the sensing area of the sensor;
configuring a target firmware program for the target operation area to allow the target operation area to respond to the control function corresponding to the target firmware program.

8. The method of claim 7, wherein configuring the target firmware program for the target operation area includes:
in response to the target event including running a game application, configuring a touch firmware program for a display interface of the game application;
in response to the target event including running a graphic editing program, configuring a stylus firmware program and/or a pressure pad firmware program in the operation interface and/or function interface of the graphic editing program;
in response to the connection between the electronic device and a stylus being established, configuring the stylus firmware program and/or the pressure pad firmware program for the target operation area.

9. The method of claim 1, wherein:
determining the target operation area in response to the target event comprises:
in response to a plurality of target events, determining one or a plurality of target operation areas; or
detecting a new target event and updating the target operation area;
configuring a control strategy corresponding to the target event for the target operation area includes at least one of:
configuring a plurality of control strategies corresponding to the plurality of target events for the a plurality of target operation areas, the control strategies being same or different; and
detecting a new target event and updating the control strategy.

10. A control apparatus, comprising:
a determination module configured to determine a target operation area in response to a target event, the target operation area belonging to an operation area formed by a hardware module of an electronic device;
a configuration module configured to configure a control strategy corresponding to the target event for the target operation area, to control the electronic device to respond to a target operation acting on the target operation area.

11. The apparatus of claim 1, wherein the determination module is configured to perform at least one of:
in response to the target event, determining the target display area of a display module of the electronic device as the target operation area;
in response to the target event, determining a sensing area of a sensor of the electronic device as the target operation area; or
in response to the target event, determining a light projection area of a naked-eye 3D display module of the electronic device as the target operation area.

12. An electronic device, comprising:
a display unit including a first screen;
an input unit including a second screen;
one or more processors; and
one or more memories storing a program that, when executed by the one or more processors, causes the one or more processors to:
in response to a target event, determine a target operation area, the target operation area belonging to the first screen or the second screen of the display unit or the input unit;
configure a control strategy corresponding to the target event for the target operation area to control the electronic device to respond to a target operation acting on the target operation area according to the corresponding control strategy.

13. The device of claim 12, wherein the one or more processors are further configured to perform at least one of:
in response to the target event, determining the target display area of a display module of the electronic device as the target operation area;
in response to the target event, determining a sensing area of a sensor of the electronic device as the target operation area; or
in response to the target event, determining a light projection area of a naked-eye 3D display module of the electronic device as the target operation area.

14. The device of claim 13, wherein the one or more processors are further configured to perform at least one of:
detecting a circle-selection operation of a target object in the target display area, and determining a circle-selection area corresponding to the circle-selection operation as the target operation area;
detecting a selection operation of the target object in the sensing area of the sensor, and determining a selection area corresponding to the selection operation as the target operation area;
in response to the target display area includes a plurality of sub-display areas, and a selection instruction of the target object for the sub-display areas, determining the selected sub-display area as the target operation area; or
in response to the target display area switching from a split-screen mode to a full-screen mode, determining the target display area in full-screen mode as the target operation area.

15. The device of claim 13, wherein the one or more processors are further configured to perform at least one of:
in response to the electronic device running a target application, determining a historical operation area of the target application in the display module as the target operation area, or determining a first display area configured for the target application in the display module as the target operation area;
in response to startup of an application having a human presence detection function, determining at least a portion of the sensing area of the sensor as the target operation area;
in response to the application being in a first operation state, determining at least a portion of the sensing area of the sensor of the electronic device as the target operation area;
in response to the application being in a second operation state, determining at least a portion of the target display area of the display module of the electronic device as the target operation area; or
in response to the application being in a third operating state, determining at least a portion of the light projection area of the naked-eye 3D display module of the electronic device as the target operation area.

16. The device of claim 13, wherein the one or more processors are further configured to perform at least one of:
in response to the electronic device changing from a first form to a second form, determining a second display area of the display module as the target operation area, the second display area being a portion or all of the display area of the display module;
in response to the electronic device changing from a third form to a fourth form, determining a first sensing area of the sensor as the target operation area, the first sensing area being a portion or all of the sensing area of the electronic device in the fourth form; or
in response to the electronic device changing from a fifth form to a sixth form, determining a first light projection area of the naked-eye 3D display module as the target operation area, wherein the first light projection area is part or all of the light projection area of the naked-eye 3D display module in the sixth form.

17. The device of claim 13, wherein the one or more processors are further configured to perform at least one of:
in response to a communication connection between the electronic device and a terminal device being established, determining a display area corresponding to identification information of the terminal device in the display module of the electronic device as the target operation area;
in response to the communication connection between the electronic device and the terminal device being disconnected, determining a third display area of the display module of the electronic device as the target operation area;
in response to the communication connection between the electronic device and a terminal device being established, determining a display area corresponding to a type of communication connection in the display module of the electronic device as the target operation area;
in response to the communication connection between the electronic device and a terminal device being established, determining a sensing area corresponding to identification information of the terminal device in the sensor of the electronic device as the target operation area, or determining a light projection area corresponding to identification information of the terminal device in the naked-eye 3D display module of the electronic device itself as the target operation area;
in response to the communication connection between the electronic device and a terminal device being disconnected, determining a second sensing area of the sensor of the electronic device as the target operation area, or determining a second light projection area in the naked-eye 3D display module of the electronic device as the target operation area;
in response to the communication connection between the electronic device and a terminal device being established, determining a sensing area corresponding to the type of communication connection in the sensor of the electronic device itself as the target operation area, or determining a light projection area corresponding to the type of communication connection in the naked-eye 3D display module of the electronic device itself as the target operation area.

18. The device of claim 12, wherein the one or more processors are further configured to:
detect the target event through a processor of the electronic device, and determine the target operation area based on the target event;
use a target controller of the electronic device to configure the target operation area in the display area of the display module and/or the sensing area of the sensor; and
configure a target firmware program for the target operation area to allow the target operation area to respond to the control function corresponding to the target firmware program.

19. The device of claim 18, wherein the one or more processors are further configured to:
in response to the target event including running a game application, configure a touch firmware program for a display interface of the game application;
in response to the target event including running a graphic editing program, configure a stylus firmware program and/or a pressure pad firmware program in the operation interface and/or function interface of the graphic editing program; and
in response to the connection between the electronic device and a stylus being established, configure the stylus firmware program and/or the pressure pad firmware program for the target operation area.

20. The device of claim 12, wherein the one or more processors are further configured to:
in response to a plurality of target events, determine one or a plurality of target operation areas; or
detect a new target event and updating the target operation area;
configure a plurality of control strategies corresponding to the plurality of target events for the plurality of target operation areas, the control strategies being same or different; and
detect a new target event and update the control strategy.
